(19) United States
(12) Patent Application Publication
(10) Pub. No.: US 2005/0156351 A1
(43) Pub. Date: Jul. 21, 2005

(54) Apparatus and method for in-mold coating an article by injecting an in-mold coating through the article

(75) Inventors: Elliott Straus, Akron, OH (US); James Bongiorno, Oxford, MI (US); Matthew Noon, Toronto (CA); Robert G. Haught, Fenton, MI (US); Robert A. Felster, Emmett, MI (US); Thomas Sinner, Baldwin, MI (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignees: OMNOVA Solutions, Inc.; Ticona LLC

(21) Appl. No.: 10/760,865

(22) Filed: Jan. 20, 2004

(51) Int. Cl. B29C 45/16

(52) U.S. Cl. 264/236; 264/255; 264/334; 425/573

(57) ABSTRACT

A molding apparatus and method is provided that allows an in-mold coating to be injected from one side of a molded article onto another show side of the molded article. A first composition injector injects a thermoplastic composition into a molding cavity of a mold to form the molded article. A second composition injector injects an in-mold coating composition into the one side of the molded article, through the molded article and onto the show side of the molded article.

### BACKGROUND OF THE INVENTION

The present invention relates to an apparatus and method for in-mold coating an article or substrate by injecting an in-mold coating composition through the article. More specifically, the invention discloses an apparatus and method for in-mold coating a thermoplastic molded article wherein an in-mold coating composition is injected from a first side of the molded article, through at least a portion of the article and onto a show surface of the article so as to spread over and coat a predetermined area of said show surface. The present invention finds particular application as an apparatus and method wherein an injection molded thermoplastic article is formed between two mold halves. An in-mold coating injector extends into a first side of the article formed adjacent one of the mold halves and passes through the article to a second or show surface of the article adjacent the other of the mold halves for in-mold coating the show surface. However, it is to be appreciated that the invention may relate to other similar environments and applications.

Molded thermoplastic and thermoset articles, such as those made from polyolefins (including, for example, polyethylenes and polypropylenes), polycarbonates, polyesters, polystyrenes, polyurethanes and the like, are utilized in numerous applications including those for the automotive, marine, recreation, construction, office products, and outdoor equipment industries. For example, automotive industry applications include wheel covers, bumpers, head and tail lamps, fenders, hoods, dashboards and body panels.

Oftentimes, it is desirable to apply a surface coating to a molded thermoplastic or thermoset article. For example, in automotive and other applications, the molded articles may be used as one or more parts in multi-part assemblies. To “match” the finish of the other parts in such assemblies, the molded articles may require application of a surface coating that has the same finish properties as the other parts. Coatings may also be used to improve surface properties of the molded articles such as uniformity of appearance, gloss, scratch resistance, chemical resistance, weatherability, and the like. In addition, surface coatings may also be used to facilitate adhesion between a molded article and a separate finish coat to be later applied to the molded article.

Numerous techniques have been developed to apply surface coatings to molded plastic articles. Many of these techniques involve the application of a surface coating to plastic articles after they are removed from their molds. These techniques are often multi-step processes involving surface preparation followed by spray-coating the prepared surface with paint or other finishes. In contrast, in-mold coating provides a means of applying a surface coating to molded plastics prior to ejection from the mold. In-mold coating can eliminate the separate manufacturing process of applying a coating to the article upon ejection from the mold thereby reducing the overall cost of manufacturing the article.

Historically, much of the work with in-mold coatings has been done on molded articles made from thermosets. Thermosets, e.g., phenolics epoxies, cross-linked polyesters, and the like, are a class of plastic materials that are chemically reactive in their fluid state and are set or cured by a reaction that causes cross-linking of the polymer chains. Once cured, subsequent heating may soften, but will not restore thermosets to a fluid condition.

More recently, there has been an interest in in-mold coating articles made from thermoplastics. Thermoplastics are a class of plastic materials that can be melted, cooled to a solid form, and repeatedly re-melted and solidified. The physical and chemical properties of many of the thermoplastic materials, together with their ease of moldability, make them materials of choice in numerous applications in the automotive, marine, recreation, construction, office products, outdoor equipment and other fields.

Because of the inherent differences between the materials, the mold designs and molding techniques used with thermosets are different than those used with thermoplastics. Molds for use with thermosets are typically designed as mated halves with shear edges. One half is typically stationary and the other half typically telescopes vertically over the stationary half. To create a molded article, an uncured thermoset is usually placed on the stationary half with the telescoping half moved apart from the stationary half. After the uncured thermoset is introduced to the mold, heat is applied to both of the mold halves and pressure is applied to the telescoping half of the mold thereby closing the mold halves and forcing and holding the uncured thermoset against the mold surface. Thus, the thermoset article is forced into shape by the movable mold half bearing down on the thermoset material. Subsequently, the formed thermoset article is allowed to cure and can then be removed or ejected from the mold.

Unlike the design of the molds typically used with thermosets, the molds used with thermoplastics usually are of a “clam shell”-like design having mated halves that meet at a parting line. One of the mated halves typically remains stationary whereas the other half of the mold is typically movable between a closed position and an open, retracted position. To form a molded article, the movable half is moved to its closed position and held closed under a clamping force thereby forming a contained molding cavity. Molten thermoplastic material is injected into the molding cavity. The molded article is formed by thoroughly filling the cavity with the thermoplastic composition and allowing the composition to sufficiently cool and solidify. During the entire molding process, the movable mold half is maintained in its closed position. After molding, the mold halves can be opened and a finished, molded article can be ejected therefrom.

Various methods have been used to apply in-mold coatings to molded thermoset and thermoplastic articles. For example, the coatings can be sprayed onto the surface of an open mold prior to closing. However, spray coating can be time-consuming and, when the coating is applied using a volatile organic carrier, may require the use of containment systems. Other in-mold coating processes involve lining the mold with a preformed film of coating prior to molding. The drawback of this in-mold coating process it that, on a commercial scale, this technique can be cumbersome and costly.

Processes have also been developed wherein a fluid coating is injected onto and dispersed over the surface of a molded thermoset part and cured. A common method of injecting a fluid in-mold coating onto the surface of a molded thermoset involves curing the article in the mold to the point that it has hardened sufficiently to accept the coating, reducing the pressure against the telescoping mold half to crack open or part the mold, injecting the fluid coating, and re-pressurizing the mold to distribute the coating over the surface of the molded article. The cracking or parting of the mold involves releasing the pressure exerted on the telescoping mold half to sufficiently move it away from the molded article creating a gap between the surface of the part and the telescoping mold half. The gap allows the coating to be injected onto the surface of the part without removing the part from the mold.

Owing to differences in mold design and molding conditions, processes wherein the mold is cracked or parted prior to injection of an in-mold coating are generally not used for the in-mold coating of injection molded thermoplastics. When molding thermoplastics, it is generally necessary to maintain pressure on the movable mold half to keep the cavity closed and prevent resin from escaping along the parting line. Further, it is often necessary to “pack” or maintain pressure on the thermoplastic material during molding which also necessitates keeping the cavity closed. Packing the mold helps to provide a more uniform crystalline or molecular structure in the molded article. Without packing, the physical properties of the molded article tend to be impaired.

In addition to the problem of resin escaping along the parting line, packing constraints can sometimes create other problems when an in-mold coating is to be injected into a mold containing a thermoplastic article. Specifically, some commercially available in-mold coatings are thermoset materials that cure by the application of heat. Were such coatings to be injected after a molded thermoplastic article has been sufficiently packed and cooled to allow the mold to be depressurized and parted or cracked, it would generally lack sufficient heat to cure the coating. Thus, for these types of coatings to cure on a thermoplastic article, they are desirably injected prior to depressurizing the mold.

Because injection molding of thermoplastics does not permit the mold to be parted or cracked prior to injection of the in-mold coating into the mold cavity, the in-mold coating must be injected under sufficient pressure to compress the thermoplastic article in all areas that are to be coated. By compressing the thermoplastic article, the in-mold coating is able to interpose between molding surfaces of the mold cavity and outer surfaces of the molded thermoplastice article. To deliver the in-mold coating at sufficient pressure, an in-mold coating injector is typically provided in one of the mold halves forming the cavity. The in-mold coating injector is separate from the injector that delivers thermoplastic resin to the cavity necessary to form the molded article. The in-mold coating injector connects to the mold cavity through an in-mold coating injector orifice located in the same mold half. This orifice is typically positioned adjacent a surface of the molded article that is to be in-mold coated. For example, if the in-mold coating injector is disposed in or on the stationary mold half, the orifice to the cavity and the surface to be coated on the article formed in the cavity are positioned in the stationary half of the mold. Further, the in-mold coating injector is positioned and oriented to inject the in-mold coating composition directly on the surface to be coated from a direction facing the surface to be coated.

In some applications it may not be feasible or possible to position the in-mold coating injector and the orifice connecting to the cavity in a position adjacent to and facing the surface of the molded article to be coated. For example, when a set of mold halves and/or an injection molding machine are retrofitted with an in-mold coating injector for in-mold coating, it may not be possible to position the in-mold coating injector and/or its orifice adjacent to and facing the surface of the molded article to be coated because of physical obstructions in the mold halves, such as heating and cooling lines running through the mold halves. Certain mold designs may also prevent positioning the in-mold coating injector and/or its orifice adjacent to and facing the surface of the molded article to be coated. These mold designs may require special resin fill designs or specific runner and sprue designs that obstruct placement of the in-mold coating injector. The stack height of one of the mold halves may also prevent positioning of the in-mold coating injector thereon because the stack height is too thin. Another reason for relocation of the in-mold coating injector may be to isolate the in-mold coating injector from heat generated at or near the thermoplastic injector which may prematurely cure a heat activated in-mold coating composition. Even if placement of the in-mold coating injector and its orifice is not physically restricted, it may not be desirable to inject an in-mold coating composition directly onto the surface to be coated because, in some applications, the injection pressure could undesirably damage the surface to be coated. Accordingly, there is a need for an apparatus and method that allows the in-mold coating injector and/or the in-mold coating orifice to be positioned in locations other than adjacent to and facing the surface to be coated.

### BRIEF SUMMARY OF THE INVENTION

In accordance with one aspect of the invention, a method for molding and in-mold coating a thermoplastic article is provided. More particularly, in accordance with this aspect of the invention, the method includes the following steps. A thermoplastic composition is heated to a temperature that is at least a melting temperature of the thermoplastic composition. The heated thermoplastic composition is injected into a mold. The injected thermoplastic composition is allowed to cool in the mold to form a molded article. The molded article has at least a first and a second surface. An in-mold coating is injected into the second surface, through the molded article and onto the first surface to in-mold coat at least a portion of the first surface of the article.

In accordance with another aspect of the invention, a molding apparatus is provided for injection molding and in-mold coating an article. More particularly, in accordance with this aspect of the invention, the molding apparatus includes a mold defining a cavity. A first composition injector has an injection inlet fluidly connected to the mold cavity. The first injector is able to inject a first composition into the mold cavity to form a molded article. The mold cavity is configured such that the molded article has a first surface, a second surface and a throughole between the first and second surface. A second composition injector has an injection inlet fluidly connected to the mold cavity. The second injector is able to inject a second composition into the second surface, through the throughole and onto the first surface.

In accordance with yet another aspect of the invention, an in-mold coated article is provided. More particularly, in accordance with this aspect of the invention, the article includes a thermoplastic having a first show surface and a second other surface. An in-mold coating composition is on at least a portion of the first surface of the thermoplastic substrate. A throughole extends through the substrate between the first and second surfaces for allowing the in-mold coating composition to be applied from the second surface and onto the show surface.

In accordance with another aspect of the invention, a method of making an article including a substrate having a coating on at least a portion of a surface of the substrate is provided. More particularly, in accordance with this aspect of the invention, the method includes the following steps. A thermoplastic material is injected into a mold cavity defined within a mold. The mold has at least a first molding surface and a second molding surface. A substrate is formed from the thermoplastic material injected into the molding cavity. The substrate has a first substrate surface formed adjacent the first molding surface and a second substrate surface formed adjacent the second molding surface. An in-mold coating composition is injected from the second molding surface through the substrate and onto the first molding surface. The injected in-mold coating composition is forced to spread out and cover a portion of the first substrate surface. A coating is formed from the in-mold coating composition on the first substrate surface.

In accordance with still another aspect of the invention, an automotive wheel cover is provided. More particularly, in accordance with this aspect of the invention, the wheel cover includes a substantially round thermoplastic substrate made by injection molding and having a show side and an opposing back side with an orifice which extends from a terminal end at the show side through to the back side. The show side has a sprue and a debossed area that encompasses the terminal end and further has a first surface with a coated area that has a coating. The area is at least partially coextensive with the first surface. The coated area surrounds the orifice. The back side has a raised area which surrounds the orifice on the back side and the debossed area includes an insert which is secured to the wheel cover through the orifice.

In accordance with still yet another aspect of the invention, a molding apparatus and method is provided. The molding apparatus and method allows an in-mold coating to be injected from the back side of a molded article onto the show surface or front side of the article. Pursuant to this aspect of the invention, it has been found that an in-mold coating composition can be injected onto the show surface from the back side of a molded thermoplastic part by providing a compression differential that makes the molded but still fluid thermoplastic resin more compressible at the point at which the coating is introduced, thereby enhancing the flowability of the coating over the surface of the part. This compression differential is achieved by thickening the part at the point of in-mold coating injection.

The present invention allows an in-mold coating injector to be positioned in a location other than one that is adjacent to and facing the surface of a molded thermoplastic article that is to be in-mold coated.

### BRIEF DESCRIPTION OF THE DRAWINGS

The invention may take physical form in various components and arrangements of components, and in various steps and arrangements of steps. The drawings are only for purposes of illustrating preferred embodiments and are not to be construed as limiting the invention.

FIG. 1 is a side view of a molding apparatus having a first, movable mold half and a second, stationary mold half according to a preferred embodiment of the present invention.

FIG. 2 is a partial cross-sectional view of the molding apparatus of FIG. 1 showing (1) the stationary mold half and the movable mold half in a closed position thereby forming a mold cavity, (2) the location of first and second injector orifices on the mold halves and (3) a molded article formed in the mold cavity.

FIG. 3 is a partial cross-sectional view of the mold halves and the molded article of FIG. 2 after an in-mold coating composition has been injected into the cavity between the stationary mold half and a show surface of the molded article.

FIG. 4 illustrates a molded article, specifically a wheel cover, which has been in-mold coated utilizing the apparatus and method of the present invention.

### DETAILED DESCRIPTION OF THE INVENTION

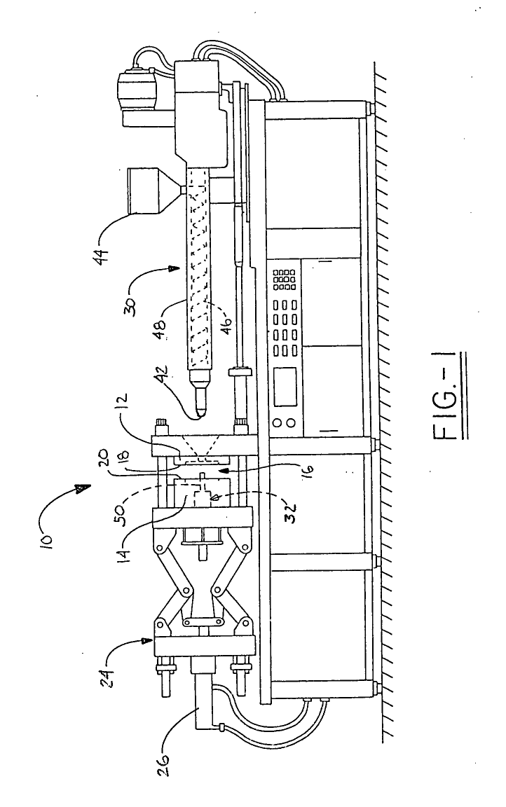

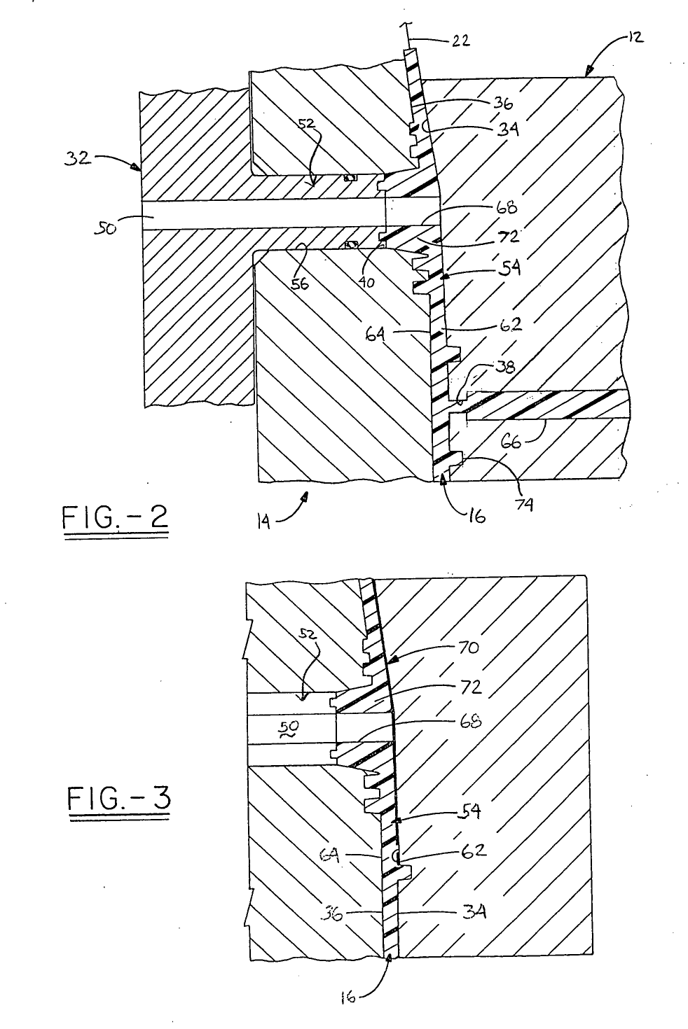

Referring now to the drawings wherein the showings are for purposes of illustrating a preferred embodiment of the invention only and not for purposes of limiting the same and like reference numerals are used to indicate like or corresponding parts throughout the several figures, FIG. 1 shows a molding apparatus or injection molding machine generally designated by reference numeral 10 in accordance with a preferred embodiment of the present invention. The molding apparatus 10 includes a first mold half 12 and a second mold half 14. The first mold half 12 preferably remains in a stationary or fixed position relative to the second movable mold half 14. In FIG. 1, the movable mold half 14 is shown in an open position. The movable mold half 14 is movable to a closed position wherein the first and second mold halves mate with one another to form a contained mold cavity 16 therebetween (See FIG. 2). More specifically, the mold halves 12,14 mate along surfaces 18 and 20 (FIG. 1) when the movable mold half 14 is in the closed position, forming a parting line 22 (FIG. 2) therebetween and around the cavity 16.

The movable mold half 14 reciprocates generally along a horizontal axis relative to the first or fixed mold half 12 by action of a clamping mechanism 24 with a clamp actuator 26 such as through a hydraulic, pneumatic or mechanical actuator as known in the art. The clamping pressure exerted by the clamping mechanism 24 should have an operating pressure in excess of the pressures generated or exerted by either one of a first composition injector 30 and a second composition injector 32. In the preferred embodiment, the pressure exerted by the clamping mechanism 24 ranges generally from about 2,000 pounds per square inch (psi) or 138 bar to about 15,000 psi or 1033 bar, preferably from about 4,000 psi or 276 bar to about 12,000 psi or 827 bar, and more preferably from about 6,000 psi or 413 bar to about 10,000 psi or 689 bar of the mold surface.

With additional reference to FIG. 2, the mold halves 12,14 are shown in a closed position abutting or mating with one another along parting line 22 to form the mold cavity 16 having a mold cavity volume. It should be readily understood by those skilled in the art that the design of the cavity 16 can vary greatly in size and shape according to the desired end product or article to be molded. The mold cavity 16 generally has a first surface 34 on the first mold half 12, upon which a show surface of an article will be formed, and a corresponding or opposite second surface 36 on the second mold half 14. The first mold half 12 defines a first orifice 38 connecting to the cavity 16 that allows the first composition injector 30 to inject its composition into the cavity 16. Similarly, the second mold half 14 defines a second orifice 40, also connecting to the cavity, that allows the second composition injector 32 to inject its composition into the cavity 16.

The first composition injector 30 is that of a typical injection molding apparatus which is well know to those of ordinary skill in the art. The first composition injector 30 is generally capable of injecting a thermoplastic composition, generally a resin or polymer, into the mold cavity 16. Owing to space constraints, the first injector 30 used to inject the thermoplastic composition is positioned to inject material from the fixed half 12 of the mold. It is to be understood that the first composition injector 30 could be reversed and placed in the movable mold half 14. Likewise, it is to be understood that the second injector 32 which is shown positioned in the movable mold half 14 could be alternatively positioned in the stationary mold half 12.

The first composition injector is shown in a “backed off” position, but it is readily understood that the same can be moved to a horizontal direction so that a nozzle or resin outlet 42 of the first injector 30 mates with the mold half 12. In the mated position, the injector 30 is capable of injecting its contents into mold cavity 16. For purposes of illustration only, the first composition injector 30 is shown as a reciprocating-screw machine wherein a first composition can be placed in a hopper 44 and a rotating screw 46 can then move the first composition through a heated extruder barrel 48, where the first composition or material is heated above its melting point. As the heated material collects in the end of the barrel 48, the screw 46 acts as an injection ram and forces the material through the nozzle 42 and into the mold cavity 16. The nozzle 42 generally has a valve (not shown) at the open end thereof and the screw 46 generally has a non-return valve (not shown) to prevent the backflow of material into the screw 46.

The first composition injector 30 is not meant to be limited to the embodiment shown in FIG. 1 but can be any apparatus capable of injecting a thermoplastic composition into the mold cavity 16. For example, the injection molding machine can have a mold half movable in a vertical direction or can be a “stack-mold” with center injection. Other suitable injection molding machines include many of those available from Cincinnati-Milacron, Inc. of Cincinnati, Ohio; Battenfeld Injection Molding Technology of Meinlerzhagen, Germany; Engel Machinery Inc. of York, Pa.; Husky Injection Molding Systems Ltd. of Bolton, Canada; BOY Machines Inc. of Exton, Pa. and others.

To make an in-mold coated thermoplastic article according to a preferred method of the present invention, with reference to FIG. 1, a thermoplastic first composition is placed in the hopper 44 of the molding apparatus 10. Suitable thermoplastic materials include, but are not limited to, polyesters, such as polyethylene terephthalate (PET), nylon, acrylonitrile butadiene styrene (ABS), polystyrene, polyacrylate, polyphenylene sulfide, polysulfone, polyurethane, styrene-acrylonitrile, polypropylene, and polyvinyl chloride (PVC). In addition, the thermoplastic material may be fiber reinforced plastic and/or a glass filled polymer. The foregoing list of thermoplastic materials is not meant to be exhaustive but only illustrative of the various thermoplastic materials useful in the practice of the invention.

Prior to injecting the first composition to form a molded article, the mold halves 12,14 are closed by the clamp mechanism 24 to create the contained molding cavity 16. In the closed position, the clamping mechanism 24 maintains a clamping pressure sufficient to maintain the mold halves 12,14 in closed relation even when the first composition and the second composition are injected into the mold cavity 16 under pressure. Also prior to injecting the first composition, the first injector 30 is moved into nesting or mating relation with the first mold half 12.

Through conventional means, i.e., using the heated extruder barrel 48 and the rotating screw 46, the first injector 30 heats the first composition above its melting point and directs the heated first composition toward the nozzle 42 of the first injector 30. If the nozzle 42 is equipped with a nozzle valve, it is moved to an open position for a predetermined amount of time to allow a corresponding quantity of the first composition to fill the molding cavity 16. The screw 46 provides an injection pressure or force that urges the first composition into the mold cavity 16 until the nozzle valve is returned to its closed position. The volume of the mold cavity 16 remains substantially constant.

More specifically, as shown in FIG. 2, the first composition flows or forms around a nozzle pin 50 of a nozzle 52 of the second composition injector 32. The first composition continues to be urged into the mold cavity 16 until the cavity 16 is filled and packed. Once the cavity 16 is filled and packed, the molded first composition is allowed to cool thereby forming a molded article 54 in the cavity 16. It is important to note the design of the nozzle 52 is such that substantially none of the first composition filling the cavity 16 is located between the nozzle pin 50 and the mold surface 34 of the mold cavity 16, i.e., the nozzle pin 50 is flush with the mold surface 34 when the nozzle pin 50 is in a closed position. The nozzle 52 is preferably in the form of an annular cylinder which extends through a passageway 56 in the second mold half 14 defining the second orifice 40.

The molded article or substrate 54 formed in the mold cavity 16 from the first composition has at least a show surface or front side 62 and an opposite surface or back side 64. The show surface 62 is the preferred viewing surface of the substrate. Because the first composition flows around the nozzle pin 50 upon injection, a passageway or throughole 68 is formed in the molded article 54. The throughole 68 extends completely through the article from the backside 64 to the show surface 62. FIG. 2 also illustrates an injection sprue 66 formed from the first composition and attached to the article 54. The injection sprue 66 is generally removed after the article 54 has been ejected or removed from the mold halves 12,14.

After the first composition has been injected into the mold cavity 16 to form the article 54 and the intended surface or surfaces to be coated have cooled below the melt point or otherwise reached a temperature or modulus sufficient to accept or support an in-mold coating, a predetermined amount of a second or in-mold coating composition is ready to be introduced into the mold cavity 16 from the nozzle 52 of second composition injector 32. If the in-mold coating composition is cured by heat then it would be desirably injected before the surfaces of the molded articles have cooled too much such that curing would be inhibited. With the volume of the mold cavity continuing to remain constant, the nozzle pin 50 is moved to an open position allowing fluid communication between the second injector 32 and the mold cavity 16 and the in-mold coating composition is injected through the nozzle 52 into the mold cavity 16 and directly onto the first mold surface 34. From the first mold surface 34, the in-mold coating composition flows radially outward onto the show surface 62. Specifically, in-mold coating composition spreads out from the mold surface 34 and coats a predetermined portion or area of the article's show surface 62. Thus, the in-mold coating composition is injected into the back side or surface 64, through the article and onto the front or show surface 62. It is important to note that the mold is not opened or unclamped before the in-mold coating is applied. That is, the mold halves 12,14 maintain the parting line 22 and generally remain substantially fixed relative to each other with the mold cavity volume remaining constant while both the first and second compositions are injected into the mold cavity 16.

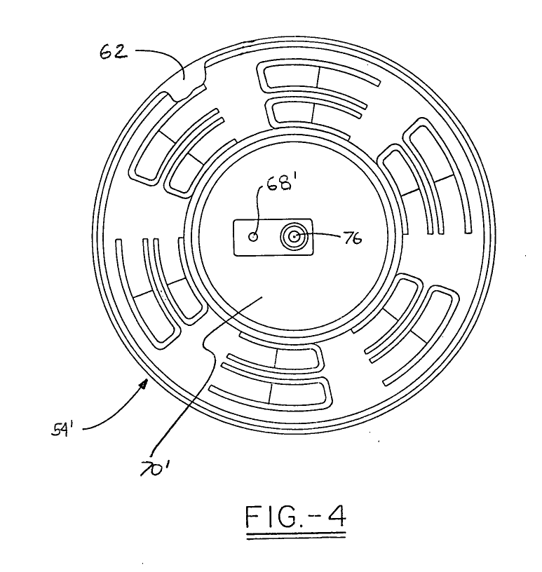

With additional reference to FIG. 3, the article 54 is shown with an in-mold coating 70 applied thereon as described above. The thickness of the coating 70 on the article 54 can vary and is generally governed by the amount of in-mold coating composition injected onto the article 54 as well as various other factors such as compressibility of the thermoplastic article 54, the mold design, etc. While the coating thickness can vary over a wide range such as from about 0.5 to about 10, 15, or even 20 mils, a desired thickness is that to stop ultraviolet light from penetrating the coating and contacting the show surface 62 of the article 54. Such a coating thickness is generally from about 3 to about 5 or about 8 mils.

In order to promote the flow of the in-mold coating 70 on the show surface 62 of the article 54, the article 54 is provided with a region or zone of compressibility 72 in the area surrounding the nozzle pin 50 where the coating is injected. This thickened or enlarged region 72 is an area extending from the back surface 36 of the article 54 that surrounds at least a portion of the nozzle pin 50. The molded article 54 can be compressed to a greater extent in region 72 than in the relatively thinner areas adjacent thereto. By incorporating a region of compressibility, such as the region 72, at the point where the coating is injected, a compression differential is created that allows the in-mold coating to spread out from the point of injection onto the show surface 62 of the molded article 54. Stated differently, the modulus of the thermoplastic article 54 is such that it can be compressed by the injection pressure of the in-mold composition permitting said composition to be interposed between mold cavity surface 34 and the thermoplastic article 54. As stated above, the clamping pressure of the mold is greater than the in-mold coating composition injection pressure.

It is also possible to incorporate substantially incompressible regions or areas into the part design to inhibit the coating from flowing onto substrate surfaces or mold areas where it is not desired. These incompressible areas may take the form of a narrow ring or relatively thin area of substrate material that extends around the perimeter of a region where the coating is not intended to flow. With reference to FIG. 2, providing the article 54 with a substantially incompressible ring or area 74 around or adjacent to the first injector orifice 38 inhibits flowback of the in-mold coating toward or into the injector nozzle 42 of the first composition injector 30.

After the predetermined amount of in-mold coating 70 is injected into the mold cavity 16 and covers or coats the predetermined area (show surface 32) of the article 54, the coated article 54 can be removed from the mold 12,14. However, before the mold halves 12,14 are parted, the in-mold coating 70 is cured by components present within the coating composition. The cure is optionally heat activated, from sources including the article 54 or mold halves 12,14 which are at or above the curing temperature of the in-mold coating 70. Cure temperature will vary depending on the in-mold coating utilized. As mentioned above, it is important to inject the in-mold coating composition, if its curing is heat activated, before the molded article 54 has cooled to the point below where proper curing of the coating 70 can be achieved. These types of in-mold coating compositions require a minimum temperature to activate the catalyst present therein which causes a cross-linking reaction to occur, thereby curing and bonding the coatings to the article.

FIG. 4 illustrates an example of an in-mold coated article prepared by the process of the present invention utilizing the apparatus described herein where like components are identified by like numerals with a prime (′) suffix and new components are defined by new numerals. In FIG. 4, the in-mold coated article 54′ is formed of a thermoplastic first composition which has been coated with in-mold thermoset coating 70′. In the example illustrated, the article 54′ is a wheelcover which can be used on an automobile, tractor, etc. Area 76 illustrates where the thermoplastic first composition was injected through the first injection orifice 38 into a mold cavity 16 to form the wheelcover. An in-mold coating injection passageway or throughole 68′ extends between the front surface of the wheelcover (shown) and the backside surface of the wheelcover (not shown). The in-mold coating 70′ has been injected onto the show surface of the article 54′ through the throughole 68′.

The process of the present invention utilizes in-mold coatings, many of which are available commercially. Such coatings include GenGlaze® and Stylecoat®, acrylic based appearance in-mold coatings available from Omnova Solutions Inc. of Fairlawn, Ohio, as well as others. These and other coatings are well known to the art. Suitable in-mold coatings are found in U.S. Pat. No. 5,777,053, herein incorporated by reference. In-mold coating injection devices are available commercially from EMC² of Sterling Heights, Mich., and Morrell of Auburn Hills, Mich.

The main advantage of acrylic coatings is the high degree of resistance to thermal and photoxidation and to hydrolysis, giving coatings that have superior color retention, resistance to embrittlement and exterior durability. Low-molecular weight acrylic resins having an average functionality of two to three and containing few molecules that are nonfunctional or only monofunctional, are useful in the present invention. Further, a preferred resin is an epoxy-based oligomer having at least two acrylate groups and at least one copolymerizable ethylenically unsaturated monomer, and at least one copolymerizable monoethylenically unsaturated compounds having a —CO—, group and a —NH₂, NH, and or —OH— group.

The present invention also contemplates the use of other resin coatings, such as alkyds, polyesters, urethane systems, amino resins, phenolic resins, epoxies and silicone resins. See e.g., Kirk Othmer, Encyclopedia of Chemical Technology, Vol. 6 (4^{th} ed. 1993) at pp. 676-690.

In-mold coatings comprising five components, namely
1) a saturated aliphatic polyester intermediate urethane
2) an aliphatic polyether
3) an aliphatic or cycloaliphatic portion (meth)acrylate
4) hydroxy alkyl (meth)acrylate
5) vinyl substituted aromatics have been found to have particular utility in the practice of this invention. In-mold coating compositions are prepared as follows. The polyester urethane acrylate is mixed with the vinyl substituted aromatic monomers such as styrene, the saturated aliphatic or cycloaliphatic (meth) acrylates such as isobornyl acrylate, and the hydroxyalkyl methacrylate, such as hydroxypropyl methacrylate. After these compounds are mixed, fillers and additives, such as cure inhibitors, light stabilizers, lubricants, etc., are added and mixed. The free radical generating initiator is added last. The poylacrylate ester of a polyol can be present in the polyester urethane acrylate from the supplier. This in-mold coating composition is clear after curing.

Any of the coatings contemplated for use in the present invention can be colored by utilizing a pigment, a colorant, etc., in a desired or effective amount to yield a desired color, tint, hue, or opacity. Pigments, pigment dispersions, colorants, etc. are well known to the art and include, for example, graphite, titanium dioxide, carbon black, phthalocyanine blue, phthalocyanine red, chromium and ferric oxides, aluminum or other metal flake, and the like.

One or more of these pigments, colorants, etc., can be utilized in suitable amounts. As known to the art, often times various pigments or colorants are added with a carrier, for example, a polyester, so that they can be easily blended. Any suitable mixing vessel can be utilized, and the various components and additives mixed until the compounds are blended. Even if pigments are not contained in the blend, the mixture at this point is not clear.

All of the above-described in-mold coating compositions that may be utilized in the present invention may contain other additives and fillers, etc., in amounts known to the art. For example, various cure inhibitors such as benzoquinone, hydroquinone, methoxyhydroquinone, p-t-butylcatechol, and the like, can also be utilized. Other additives may include an accelerator, such as cobalt octoate. Other classes of accelerators include zinc, or other metal carboxylates. Various light stabilizers can also be utilized such as, for example, the various hindered amines (HALS), substituted benzophenones, and substituted benztriazoles, and the like. Lubricants and mold release agents are generally utilized with specific examples including various metal stearates, such as zinc stearate or calcium stearate or phosphonic acid esters. Reinforcing fillers, such as talc, can be utilized. Other additives include hardeners, thixotropes, such as silica, and adhesion agents, such as polyvinyl acetate.

The invention has been described with reference to the preferred embodiments. Obviously, modifications and alterations will occur to others upon reading and understanding the preceding detailed description. It is intended that the invention be construed as including all such modifications and alterations.

1. A method for molding and in-mold coating a thermoplastic article, the method comprising the steps of:
(a) heating a thermoplastic composition to a temperature that is at least a melting temperature of the thermoplastic composition;
(b) injecting the heated thermoplastic composition into a mold;
(c) allowing the injected thermoplastic composition to cool in the mold to form a molded article, the molded article having at least a first and a second surface; and
(d) injecting an in-mold coating adjacent the second surface, through the molded article and onto the first surface to in-mold coat at least a portion of the first surface of the article.

2. The method of claim 1 further including the step of packing the thermoplastic composition into the mold by maintaining the composition under sufficient pressure.

3. The method of claim 1 wherein the step of injecting the in-mold coating includes the substeps of:
(i) injecting the in-mold coating composition into the second surface;
(ii) directing the in-mold coating composition through the molded article and directly into a surface of the mold; and
(iii) continuing to inject the in-mold coating composition adjacent the second surface to force the in-mold coating composition directed through the molded article and directly into the surface of the mold onto at least a portion of the first surface.

4. The method of claim 1 further including the steps of:
curing the in-mold coating injected onto the first surface; and
removing the coated article from the mold.

5. The method of claim 1 wherein the mold has a substantially constant mold volume throughout steps (a) through (d).

6. The method of claim 1 wherein the molded article has an area of increased thickness adjacent a location where the in-mold coating composition passes through the molded article to assist the in-mold coating composition in spreading out across the first surface to in-mold coat at least a portion of the first surface.

7. The method of claim 1 wherein the coating composition covers a predetermined area of the first surface.

8. The method of claim 1 wherein the thermoplastic composition is injected from a first half of the mold and the in-mold coating composition is injected from a second half of the mold, the first half adjacent the first surface and the second half adjacent the second surface.

9. The method of claim 1 wherein the in-mold coating composition is injected when at least a portion of the first surface of the article has achieved a sufficient modulus to support the in-mold coating composition.

10. A molding apparatus for injection molding and in-mold coating an article, comprising:
a mold defining a mold cavity;
a first composition injector fluidly connected to the mold cavity, the first injector able to inject a first composition into the mold cavity to form a molded article;
the mold cavity configured such that the molded article has a first surface, a second surface and a throughole between the first surface and the second surface; and
a second composition injector fluidly connected to the mold cavity, the second injector able to inject a second composition into the second surface, through the throughhole and onto the first surface.

11. The molding apparatus of claim 10 wherein said first composition injector is a thermoplastic injector.

12. The molding apparatus of claim 10 wherein said second composition injector is an in-mold coating composition injector.

13. The molding apparatus of claim 10 wherein the mold includes a first mold half and a second mold half, the first injector positioned to inject into the cavity from the first mold half and the second injector positioned to inject into the molded article in the cavity from the second mold half and in-mold coat the first surface formed adjacent the first mold half.

14. The molding apparatus of claim 13 wherein the second composition injector includes a nozzle extending from said second mold half into the mold cavity, through the molded article and terminating at a surface of said first mold half to thereby direct the second composition directly into the surface of the first mold half prior to the second composition coating the first surface.

15. The molding apparatus of claim 10 wherein the second injector extends into the cavity to form the throughole in the molded article.

16. An in-mold coated article, comprising:
a thermoplastic substrate having a first show surface and a second other surface;
an in-mold coating composition on at least a portion of the first surface of the thermoplastic substrate; and;
a throughole extending through the substrate between the first and second surfaces for allowing the in-mold coating composition to be applied from the second surface and onto the show surface.

17. The article of claim 16 wherein the throughole has a circular cross-section.

18. The article of claim 16 wherein the article is one of a wheel cover, a bumper, a head lamp, a tail lamp, a fender, a hood, a dashboard, and a body panel.

19. A method of making an article including a substrate having a coating on at least a portion of a surface of the substrate, the method comprising the steps of:
injecting a thermoplastic material into a mold cavity defined within a mold, the mold having at least a first molding surface and a second molding surface;
forming a substrate from the thermoplastic material injected into the molding cavity, the substrate having a first substrate surface formed adjacent the first molding surface and a second substrate surface formed adjacent the second molding surface;
injecting an in-mold coating composition from the second molding surface through the substrate and onto the first molding surface;
forcing the injected in-mold coating composition to cover a portion of the first substrate surface; and
forming a coating from the in-mold coating composition on the first substrate surface.

20. The method of claim 19 wherein the mold cavity has a substantially constant volume.

21. The method of claim 19 wherein the step of forcing the injected in-mold coating composition to spread includes the substep of:
promoting the flow of the in-mold coating composition over the portion of the first substrate surface by providing an area of increased compressibility adjacent a location that the in-mold coating composition engages the first substrate surface.

22. The method of claim 19 including the further step of:
preventing the flow of the in-mold coating composition on portions of the substrate by forming the substrate with areas of decreased compressibility.

23. An automotive wheelcover comprising a substantially round thermoplastic substrate made by injection molding and having a show side and an opposing back side with throughole which extends from a terminal end at the show side through to the back side, the show side having a sprue and a debossed area that encompasses the terminal end and further having a first surface with a coated area that has a coating, said area being at least partially coextensive with the first surface, said coated area surrounding said throughole, and the back side having a raised area which surrounds the throughole on said back side and the debossed area including an insert which is secured to the wheelcover through the throughole.

24. The automotive wheelcover of claim 23 wherein the thermoplastic substrate further includes fibers or glass filler or reinforcement.

25. The automotive wheelcover of claim 23 wherein the throughole has a circular cross-section and the coated area is substantially circular.
